(19) United States
(12) Patent Application Publication
(10) Pub. No.: US 2011/0239842 A1
(43) Pub. Date: Oct. 6, 2011

(54) ADAPTABLE PIPE INSTRUMENT & METHODS OF USE THEREOF

(76) Inventor: Paul Humphreys, Los Angeles, CA (US)

(21) Appl. No.: 13/163,419

(22) Filed: Jun. 17, 2011

Related U.S. Application Data
(63) Continuation of application No. 12/639,952, filed on Dec. 16, 2009, now abandoned.
(60) Provisional application No. 61/138,070, filed on Dec. 16, 2008.

(51) Int. Cl. G10B 3/08; G09B 15/00

(52) U.S. Cl. 84/349; 84/470 R

(57) ABSTRACT

Embodiments of the invention are directed to an adaptable panpipe instrument and methods of use thereof. In one embodiment, the adaptable panpipe instrument includes a collar brace with a plurality of openings. The plurality of openings may be of the same size or varying sizes and are capable of receiving pipe components of a panpipe instrument. When a plurality of pipe components are positioned within the collar brace in a given configuration, it may be secured to the brace by friction-fit, a webbing, and/or one or more fasteners. One or more of the plurality of pipe components may be adjusted relative to the other pipe components by sliding them up or down which may also adjust the musical scale of that pipe.

### CLAIM OF PRIORITY UNDER 35 U.S.C. §119

The present application for patent claims priority to U.S. Provisional Application No. 61/138,070 entitled “Adaptable Pipe Instrument & Methods of Use Thereof”, filed Dec. 16, 2008, and to U.S. Utility patent application Ser. No. 12/639,952 “Adaptable Pipe Instrument & Methods of Use Thereof”, filed Dec. 16, 2009, both of which are hereby expressly incorporated by reference herein.

### FIELD OF INVENTION

At least one feature pertains to an adaptable pipe instrument and methods of use thereof.

### BACKGROUND OF INVENTION

The pan flute or pan pipe (also known as panflute or panpipes) is a musical instrument based on the principle of the closed tube, consisting usually of five or more pipes of gradually increasing length and, in some configurations, varying girth. The pipes comprising it are stopped at one end, at which the standing wave is reflected giving a note an octave lower than that produced by an open pipe of equal length.

The acoustic properties of the pan flute are in the Helmholtz oscillator class of closed tube acoustics. Generation of a fundamental frequency is produced by blowing across the open end of the tube, thus creating a Von Karman vortex street by means of a siphon effect at the top of the tube. The tuned resonator body then supports this frequency. The pan flute is played by blowing horizontally across the open end against the sharp inner edge of the pipes. Each pipe is tuned to a keynote, called the fundamental frequency.

Panpipes are generally in a fixed configuration. FIG. 1 illustrates a panpipe in a fixed configuration. Examples of fixed configuration panpipes include, but are not limited to, curved configuration panpipes (e.g., 8 or 12 tubes, key of C) or straight configuration panpipes (e.g., one octave in C or two octaves in C). Because the pipes are fixed, the musician may be limited with respect to the music he/she may produce. For example, if the musician plays varying styles of music, he/she may have to change panpipe instruments to play each particular style, e.g., in order to achieve various musical notes that may not be possible with a single panpipe. Additionally, when learning to play the panpipe, it is often advantageous to allow a student to focus on a subset of pipes rather than the whole set. However, prior art panpipes do not easily allow a student to focus on just a subset of the pipes.

Consequently, an adjustable means to vary the types of music (e.g., the subset of pitches and/or scales) capable of being played on a panpipe is desirable.

### SUMMARY OF INVENTION

An adjustable pipe instrument is provided comprising of: (i) a collar brace having a plurality of openings therein, the plurality of openings in a linear or curved array; and (ii) a plurality of pipe components positioned within the plurality of openings, each pipe component vertically adjustable within each opening to achieve a predetermined configuration, each predetermined configuration resulting in a predetermined musical scale is herein disclosed. The plurality of openings may decrease in diameter from a proximal end of the collar brace to a distal end of the collar brace. The plurality of openings for the pipe components may include openings of at least two different diameters. Alternative, the plurality of openings for the pipe components may include at least two openings of the same diameter.

In some embodiments the plurality of pipe components may decrease in length from a proximal end of the collar brace to a distal end of the collar brace. The collar brace may be one of linear shaped or curved shaped. The musical scale may be configurable among one of diatonic, pentatonic, hexatonic, heptatonic, octatonic, chromatic or whole tone. In some embodiments, each of the plurality of openings is numbered and each of the plurality of pipe components is numbered wherein each numbered opening corresponding to a numbered pipe component. In some embodiments, each pipe component includes at least one score marker wherein each score marker corresponding to a predetermined position of the pipe component relative to the collar brace within a corresponding opening. Each pipe component may be independently adjustable within a corresponding opening relative to other pipe components.

A method of configuring an adjustable pipe instrument, comprising: (i) selecting a melody from an instrument manual; (ii) selecting a plurality of pipe components corresponding to the selected melody; (iii) positioning the plurality of pipe components in a predetermined configuration within a collar brace having a plurality of openings; (iv) vertically adjusting the plurality of pipe components within the collar brace corresponding to the selected melody; and (v) securing the plurality of pipe components to the collar brace is herein disclosed. Vertically adjusting may comprise positioning a pipe component such that a score marker thereon is substantially adjacent to a circumference defining a corresponding opening.

A kit for teaching to play an adjustable pipe instrument, comprising: (i) a configurable panpipe including a collar brace having a plurality of openings to receive a plurality of pipe components; (ii) a plurality of pipe components wherein the collar braced is adapted to receive a subset of the plurality of pipe components; and (iii) a book instructing a user on how to play and use the panpipe. The plurality of openings may be in a linear or curved array. The plurality of openings for the pipe components may include openings of at least two different diameters or of the same diameter. The plurality of pipe components may decrease in length from a proximal end of the collar brace to a distal end of the collar brace. In some embodiments, each of the plurality of openings is numbered and each of the plurality of pipe components is numbered wherein each numbered opening corresponding to a numbered pipe component. In some embodiments, each pipe component includes at least one score marker, each score marker corresponding to a predetermined position of the pipe component relative to the collar brace within a corresponding opening. In some embodiments, each pipe component is independently adjustable within a corresponding opening relative to other pipe components.

### BRIEF DESCRIPTION OF THE DRAWINGS

FIG. 1 illustrates a panpipe in a fixed configuration.

FIG. 2A shows a bottom view of a collar brace according to an embodiment of the invention.

FIG. 2B illustrates a perspective view of collar brace 100 in FIG. 2A.

FIG. 3 shows a plurality of pipe components according to an embodiment of the invention.

FIG. 4A shows an adaptable pipe instrument according to an embodiment of the invention in a DO pentatonic configuration.

FIG. 4B shows an adaptable pipe instrument according to an embodiment of the invention in a SOL pentatonic configuration.

FIG. 4C shows an adaptable pipe instrument according to an embodiment of the invention in a major diatonic configuration.

FIG. 5A illustrates a side view of an adaptable pipe instrument according to an embodiment of the invention.

FIG. 5B illustrates a top view of a collar brace according to an embodiment of the invention.

FIG. 5C illustrates a side view of an adjustable pipe instrument according to an embodiment of the invention.

FIG. 6 illustrates a perspective view of an adaptable pipe instrument according to an embodiment of the invention.

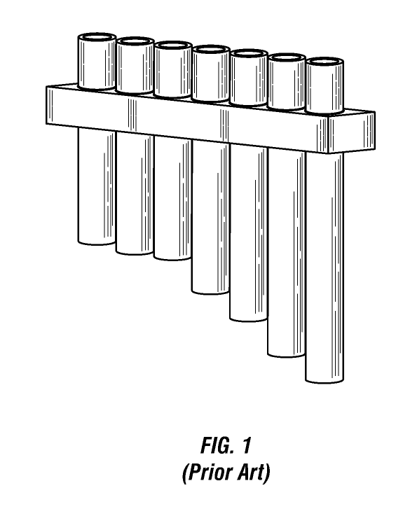

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to an adaptable panpipe instrument and methods of use thereof. In one embodiment, the adaptable panpipe instrument includes a collar brace with a plurality of openings. The plurality of openings may be of the same size or varying sizes and are capable of receiving pipe components of a panpipe instrument. When a plurality of pipe components are positioned within the collar brace in a given configuration, it may be secured to the brace by friction-fit, a webbing, and/or one or more fasteners.

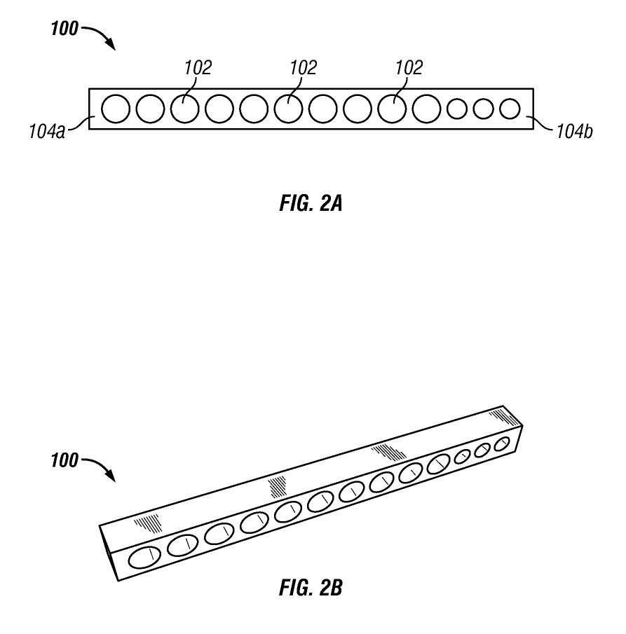

FIG. 2A shows a bottom view of a collar brace according to an embodiment of the invention. The collar brace 100 may have a straight elongated shape; however, other geometric shapes are within the scope of the invention. For example, the collar brace 100 may have a curved configuration. The collar brace 100 may include a plurality of approximately circular openings 102 of varying diameter or, alternatively, of the same diameter. The number of openings 102 may vary. For instance, various implementations of the collar brace 100 may have between two (2) and thirty (30) openings. In one embodiment, the number of openings 102 is thirteen (13). The plurality of openings 102 may decrease in diameter from a proximal end 104a to a distal end 104b of the collar brace 100, or vice-versa. In one embodiment, the plurality of openings 102 may be numbered to match a corresponding pipe component (explained in more detail below).

The collar brace 100 may have a length from about three (3) inches to about forty (40) inches, preferably approximately nine (9) inches in the embodiment in which the collar brace 100 includes thirteen (13) openings 102. Also, the collar brace 100 may have a width slightly larger a diameter of the largest pipe to be used in conjunction with the collar brace 100. For example, the width of the collar brace may be between about 0.5 inches to about three (3) inches, preferably approximately 0.75 inches. Note that the width of the collar brace 100 may vary from the proximal end 104a to the distal end 104b. Also, the collar brace 100 may have a height of about 0.25 inches to about four (4) inches, preferably about one (1) inch. Again, the height of the collar brace 100 may vary from the proximal end 104a to the distal end 104b. The collar brace 100 may be made of various materials, such as a ceramic material, wood material, plastic, metal, or equivalent materials. FIG. 2B illustrates a perspective view of collar brace 100 in FIG. 2A.

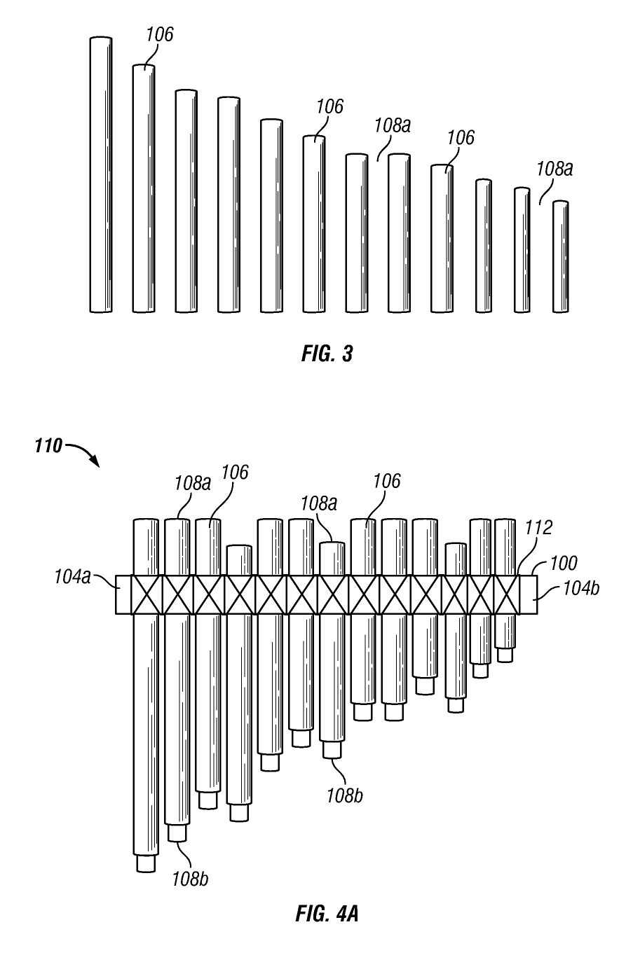

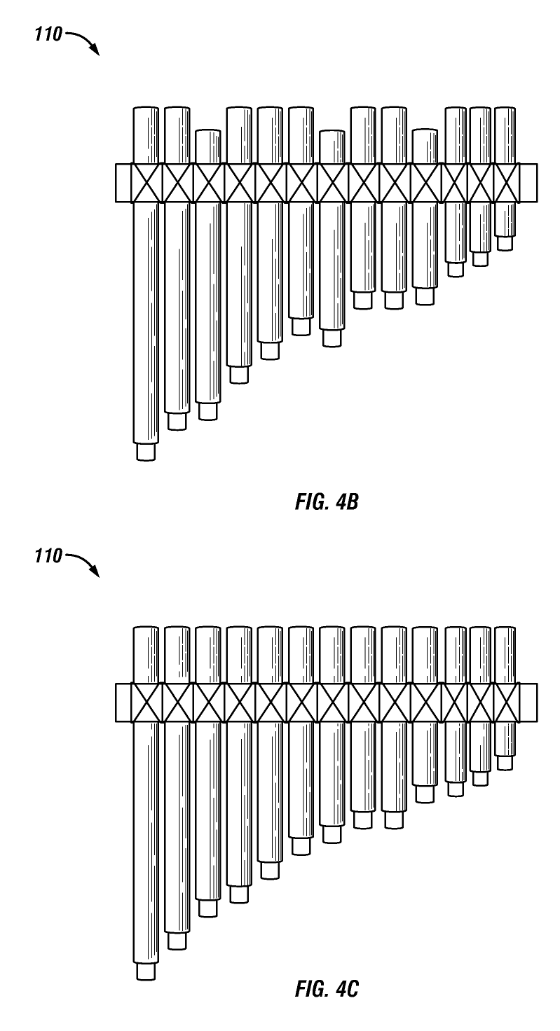

FIG. 3 shows a plurality of pipe components according to an embodiment of the invention. The plurality of pipe components 106 may be a variety of lengths and/or diameters as shown. For example, a pipe component 106 may have a length from about one (1) inch to about forty-eight (48) inches and a diameter from about ⅛ of an inch to about three (3) inches. The sound emitted from each pipe component 106 (in addition to other factors, such as over-blowing by the musician) is partially a function of the length and the diameter of the given pipe component 106. Each pipe component 106 may have an open end 108a and a closed end 108b (not shown, see FIGS. 4A-4C). A variety of components may be used to effectuate closed end 108b, such as stoppers, caps or integrated closed ends. Generally, the closed end 108b affects the tone emanating from a given pipe component 106, i.e., it varies the sound/pitch produced by an open pipe of equal length. Each pipe component 106 may be made of plastic, wood, metal, composite materials and/or suitable material.

FIGS. 4A-4C show various configurations of an adaptable pipe instrument according to embodiments of the invention. In some embodiments, an adaptable pipe instrument 110 may be hand-held. FIG. 4A shows an adaptable pipe instrument 110 in a DO pentatonic configuration. As shown, a plurality of pipe components 106 are situated within the plurality of openings 102 (not shown) of the collar brace 100 and secured by a webbing 112. According to this configuration, the plurality of pipe components 106 is in a straight or linear configuration and each pipe component 106 decreases in length from the proximal end 104a to the distal end 104b of the collar brace 100. Each pipe component 106 may have the same or different diameters relative to one another. As shown, the open end 108a of each pipe component 106 is positioned at a specific height relative to the collar brace 100. The positioning of each pipe component 106 in a particular array may be designed to achieve a specific musical scale or pitch. Examples of musical scales include, but are not limited to, diatonic (major and minor), pentatonic, hexatonic, heptatonic, octatonic, chromatic, whole tone. The collar brace 100 according to embodiments of the invention allows for pipe components 106 of varying lengths to be introduced to accommodate musical scales around the world, e.g., Arabic Maqam-s, Persian Dastgah-s, South Asian Rag-s and Raga-s. The collar brace 100 allows adjusting the position of a component pipe independently of the other component pipes by sliding (or even removing) the component pipe relative to the collar brace 100 and/or the other component pipes.

In one embodiment, the plurality of openings 102 is numbered from 1 to n to match a corresponding pipe component 106 also numbered from 1 to n. For example, an instruction manual may provide instructions to a musician on which pipe components 106 to use and where and how to position those pipe components 106 within the collar brace 100 to achieve a particular musical scale or to play a particular melody. In one embodiment, each pipe component 106 may be scored (i.e., may have one or more score markers) so that the musician knows how to vertically adjust each pipe component 106 within each corresponding opening 102 according to the instruction manual. FIG. 4A illustrates one such configuration where some of the pipe components 106 have been lowered, allowing the user to focus on the other pipes for a particular lesson or piece of music. These aspects of embodiments of the invention may be beneficial to, for example, a novice learning how to play a panpipe. That is, the adaptability provided by the collar brace 100 facilitates configuring the panpipe instrument however desired.

Moreover, adaptable pipe instruments according to embodiments of the invention allow the instrument to be customizable. That is, the musician may customize the adaptable pipe instrument to achieve different melodies or styles of music without having to change instruments. FIG. 4B shows an adaptable pipe instrument 110 in a SOL pentatonic configuration. FIG. 4C shows an adaptable pipe instrument 110 in a major diatonic configuration. Any combination of pipe components 106 of varying sizes and varying positions on collar 100 are within the scope of the invention.

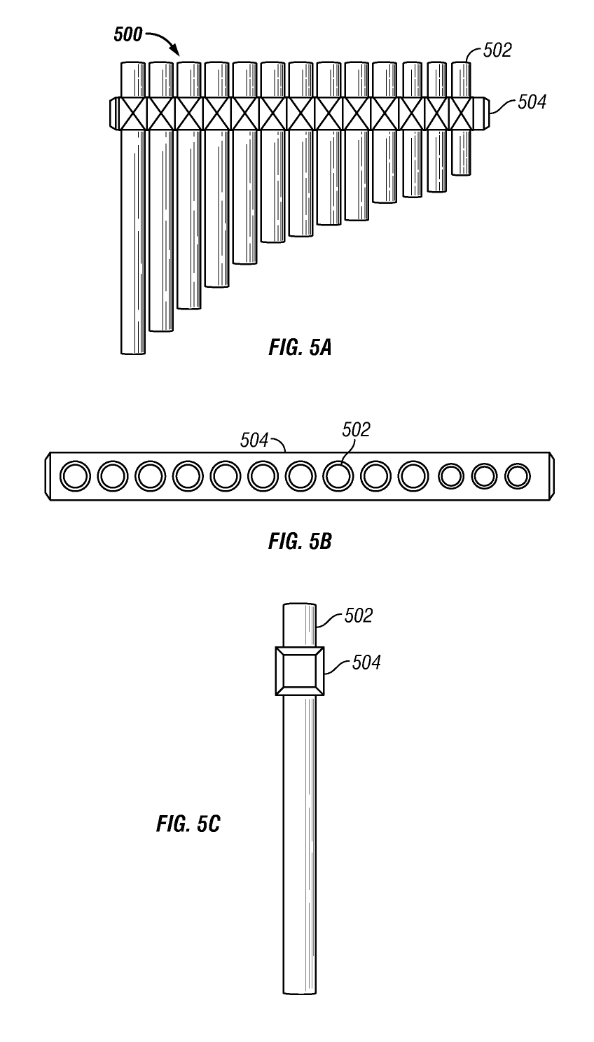

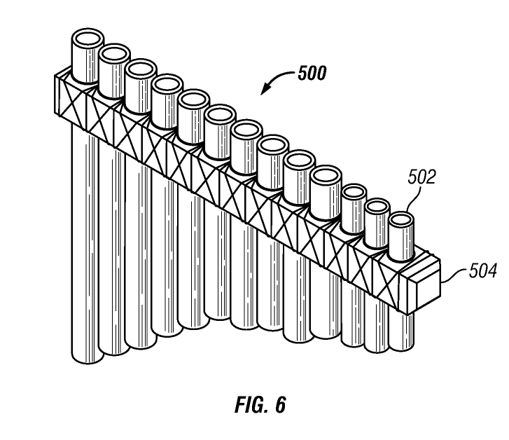

FIG. 5A illustrates a side view of an adaptable pipe instrument 500 according to an embodiment of the invention. As illustrated, the adaptable pipe instrument 500 mya include a collar brace 504 that receives a plurality of pipes 502. FIG. 5B illustrates a top view of a collar brace 504 and pipes 502 according to an embodiment of the invention. FIG. 5C illustrates a side view of an adjustable pipe instrument 500 according to an embodiment of the invention. FIG. 6 illustrates a perspective view of the adaptable pipe instrument 500 according to an embodiment of the invention. The embodiments of adaptable pipe instruments and/or collar brace as illustrated in FIGS. 5A-5C and FIG. 6 may have none, some, substantially all or all of the features as described previously.

Thus, according to some methods of the invention, a user (i.e., musician) may select a predetermined melody from an instrument manual. The musician may select the appropriate pipe components 106 according to the selected melody (i.e., a subset of pipe components 106) and then position those pipe components 106 within a collar brace 100 having a plurality of openings 102. The musician may then vertically adjust the pipe components 106 (relative to collar brace 100) such that a score marker thereon is substantially adjacent to a circumference defining a corresponding opening 102 to ready the instrument for the selected melody. According to embodiments of the invention, each pipe component 106 may be independently adjustable relative to another pipe components 106. In some embodiments, a webbing 112 may be added to the collar brace 100 for decorative purposes and/or to hold each pipe component 106 in place.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

What is claimed is:

1. An adjustable pipe instrument, comprising:
a collar brace having a plurality of openings therein, the plurality of openings in a linear or curved array; and
a plurality of pipe components positioned within the plurality of openings, each pipe component vertically and slidably adjustable within each opening to achieve a predetermined configuration, each predetermined configuration resulting in a predetermined musical scale.

2. The adjustable pipe instrument of claim 1 wherein the plurality of openings decrease in diameter from a proximal end of the collar brace to a distal end of the collar brace.

3. The adjustable pipe instrument of claim 1 wherein the plurality of openings for the pipe components include openings of at least two different diameters.

4. The adjustable pipe instrument of claim 1 wherein the plurality of openings for the pipe components include at least two openings of the same diameter.

5. The adjustable pipe instrument of claim 1 wherein the plurality of pipe components decrease in length from a proximal end of the collar brace to a distal end of the collar brace.

6. The adjustable pipe instrument of claim 1 wherein the collar brace is one of linear shaped or curved shaped.

7. The adjustable pipe instrument of claim 1 wherein the musical scale is configurable among one of diatonic, pentatonic, hexatonic, heptatonic, octatonic, chromatic or whole tone.

8. The adjustable pipe instrument of claim 1 wherein each of the plurality of openings is numbered and each of the plurality of pipe components is numbered, each numbered opening corresponding to a numbered pipe component.

9. The adjustable pipe instrument of claim 1 wherein each pipe component includes at least one score marker, each score marker corresponding to a predetermined position of the pipe component relative to the collar brace within a corresponding opening.

10. The adjustable pipe instrument of claim 1 wherein each pipe component is independently adjustable within a corresponding opening relative to other pipe components.

11. A method of configuring an adjustable pipe instrument, comprising:
selecting a melody from an instrument manual;
selecting a plurality of pipe components corresponding to the selected melody;
positioning the plurality of pipe components in a predetermined configuration within a collar brace having a plurality of openings;
vertically and slidably adjusting the plurality of pipe components within the collar brace corresponding to the selected melody; and
securing the plurality of pipe components to the collar brace.

12. The method of claim 11 wherein vertically adjusting comprises positioning a pipe component such that a score marker thereon is substantially adjacent to a circumference defining a corresponding opening.

13. A kit for teaching to play an adjustable pipe instrument, comprising:
a configurable panpipe including a collar brace having a plurality of openings to receive a plurality of pipe components;
a plurality of pipe components wherein the collar braced is adapted to receive a subset of the plurality of pipe components; and
a book instructing a user on how to play and use the panpipe.

14. The kit of claim 13 wherein the plurality of openings are in a linear or curved array.

15. The kit of claim 13 wherein the plurality of openings for the pipe components include openings of at least two different diameters.

16. The kit of claim 13 wherein the plurality of openings for the pipe components include at least two openings of the same diameter.

17. The kit of claim 13 wherein the plurality of pipe components decrease in length from a proximal end of the collar brace to a distal end of the collar brace.

18. The kit of claim 13 wherein each of the plurality of openings is numbered and each of the plurality of pipe components is numbered, each numbered opening corresponding to a numbered pipe component.

19. The kit of claim 13 wherein each pipe component includes at least one score marker, each score marker corresponding to a predetermined position of the pipe component relative to the collar brace within a corresponding opening.

20. The kit of claim 13 wherein each pipe component is independently adjustable within a corresponding opening relative to other pipe components.
